(19) United States
(12) Patent Application Publication
(10) Pub. No.: US 2010/0034507 A1
(43) Pub. Date: Feb. 11, 2010

(54) APPARATUS AND METHOD FOR SEALING SMALL TUBES OF A BLOWN-FIBER CABLE ON INSERTION INTO COLLAR

(75) Inventor: Michael Sielaff, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/536,058

(22) Filed: Aug. 5, 2009

(30) Foreign Application Priority Data
Aug. 8, 2008 (DE) 10 2008 037 126.2

(51) Int. Cl. G02B 6/00

(52) U.S. Cl. 385/139; 385/134

(57) ABSTRACT

The invention relates to an apparatus (1) for sealing small tubes (11, 12) of a blown-fiber cable (10) on insertion into a collar (50), comprising a sealing element (2), a splitting element (3), a bundling element (4) and at least one covering element, with the sealing element (2) having a number of seals (24) corresponding to the number of small tubes (11, 12), with the splitting element (3) being arranged on the cable side before the sealing element (2), and with the bundling element (4) being arranged on the collar side behind the sealing element (2), and to an associated method.

This application claims benefit of Ser. No. 10 2008 037 126.2, filed 8 Aug. 2008 in Germany and which application is incorporated herein by reference. To the extent appropriate, a claim of priority is made to the above disclosed applications.

### BACKGROUND

The invention relates to an apparatus and a method for sealing small tubes of a blown-fiber cable on insertion into a collar.

Collars for glass fiber cables have two fundamentally different sealing systems, specifically elastomer cable seals in the housing lower part of the collar, or else shrink sleeves.

Recently, novel types of glass fiber cables have been developed, so-called blown-fiber cables. These have a multiplicity of small tubes through which fibers can be blown subsequently by means of compressed air. These cables are extremely rigid, as a result of which their direct insertion into the collar leads to difficulties in subsequent movement of the collar.

In order to solve the problem, it is feasible to partially strip the cable and to insert the small tubes directly into the collar. The small tubes could then be protected outside the collar by a flexible tube, which is then passed to the collar. However, this leads to sealing problems on the collar if the flexible tube is damaged.

### SUMMARY

The invention is based on the technical problem of providing an apparatus and a method for sealing small tubes of a blown-fiber cable on insertion into a collar.

For this purpose, the apparatus for sealing small tubes of a blown-fiber cable on insertion into a collar comprises a sealing element, a splitting element, a bundling element and at least one covering element, with the sealing element having a number of seals corresponding to the number of small tubes, with the splitting element being arranged on the cable side before the sealing element, and with the bundling element being arranged on the collar side behind the sealing element. This makes it possible to seal each small tube including the core individually, in such a way that no moisture can penetrate into the collar along the small tubes. The spread-out cable is then combined again in a compact form, by the bundling element. In this case, the covering element is located at least over the sealing element, and extends as far as the collar. In this case, it should be noted that the sealing element may also have more seals than small tubes, in which case the unused seals must then be closed, for example by means of a membrane. The sealing element is preferably composed of an elastomer. Furthermore, the splitting element, the sealing element and the bundling element are preferably connected to one another, for example by latching, adhesive bonding or screwing.

The seals are preferably arranged concentrically on the sealing element in which case, furthermore, at least two rings of seals preferably exist. This allows the small tubes to be routed sufficiently far apart from one another, thus simplifying the handing when passing the small tubes through the sealing element.

In a further preferred embodiment, the seals have outward bulges in the form of truncated cones on the collar side. This results in a good sealing effect in a very simple manner, even if the small tubes have different diameters. Alternatively, the outward bulges can also be hollow-cylindrical.

In a further preferred embodiment, the covering elements are in the form of two elements with a cap and a tubular attachment, with the caps surrounding the sealing element. The two caps can in this case be connected to one another in a moisture-tight manner for example by latching, screwing, adhesive bonding or in some other way. The tubular attachment on the collar side is in this case used for insertion into the collar, with the tubular attachment being sealed by means of an elastomer seal on insertion into the collar, with the tubular attachment on the cable side being used for connection by means of a shrink sleeve to the cable sheath or to a flexible tube which is pushed on instead of it. When using a flexible tube, a further shrink sleeve is then preferably used for connection of the cable sheath and flexible tube.

The outer small tubes are preferably shorter than the inner small tubes, such that the inner small tubes are passed through the sealing element first of all followed by the outer small tubes, thus making handling easier. The small tubes are then cut to approximately the same length again within the collar at a later time.

### BRIEF DESCRIPTION OF THE DRAWINGS

The invention will be explained in more detail in the following text with reference to one preferred exemplary embodiment. In the figures:

FIG. 1 shows an exploded illustration of an apparatus for sealing small tubes of a blown-fiber cable,

FIG. 2 shows a perspective illustration of a blown-fiber cable,

FIG. 3a shows a plan view of the cable side of a splitting element,

FIG. 3b shows a side view of the splitting element,

FIG. 3c shows a section illustration of the splitting element along the section X-X in FIG. 3a,

FIG. 3d shows a plan view of the collar side of the splitting element,

FIG. 3e shows a perspective illustration of the splitting element from the cable side,

FIG. 3f shows a perspective illustration of the splitting element from the collar side,

FIG. 4a shows a cable-side plan view of a sealing element,

FIG. 4b shows a side view of the sealing element,

FIG. 4c shows a collar-side plan view of the sealing element,

FIG. 4d shows a perspective illustration of the sealing element from the cable side,

FIG. 4e shows a perspective illustration of the sealing element from the collar side,

FIG. 5a shows a cable-side plan view of a bundling element,

FIG. 5b shows a sectional illustration along the section X-X shown in FIG. 5a, and

FIG. 6 shows a perspective illustration of the apparatus for sealing a blown-fiber cable on insertion into a collar.

### DETAILED DESCRIPTION

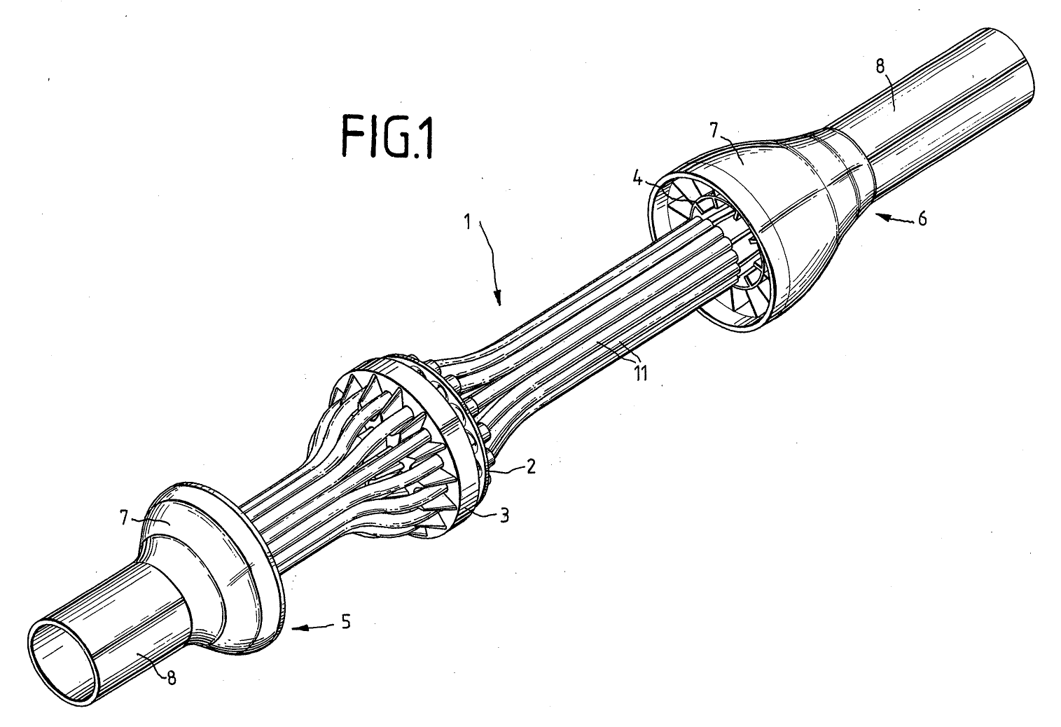

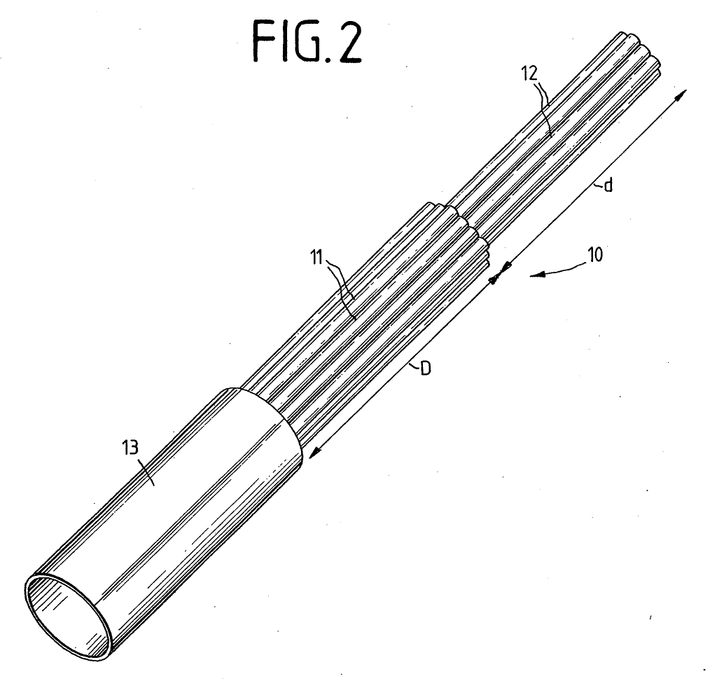

The apparatus 1 shown in FIG. 1 for sealing small tubes 11, 12 of a blown-fiber cable 10 (see FIG. 2) comprises a sealing element 2, a splitting element 3, a bundling element 4 and two covering elements, which are in the form of elements 5, 6 with a cap 7 and a tubular attachment 8. The apparatus 1 is used to seal a blown-fiber cable 10 by means of elastomer seals, on insertion into a collar.

In a first step, the blown-fiber cable 10 is partially stripped, with the outer small tubes 11 being cut off to be shorter than the inner small tubes 12. By way of example, the distance D from the end face of the outer small tubes 11 to the sheath 13 of the blown-fiber cable 10 is approximately 2-3 m, while in contrast the distance d between the end faces of the inner small tubes 12 and the end faces of the outer small tubes 11 is about 0.1 m.

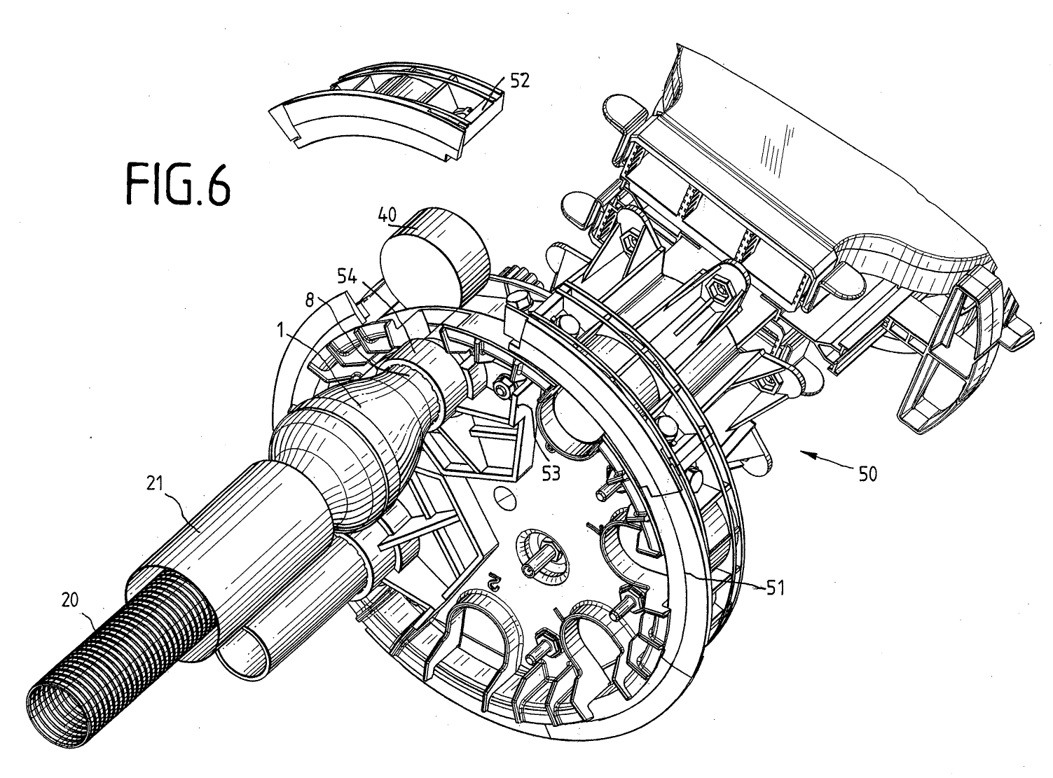

The small tubes 11, 12 are then passed through a flexible tube 20 and two shrink sleeves 21 (see FIG. 6). In this case, one shrink sleeve is used for connection of the sheath 13 of the blown-fiber cable 10 to the flexible tube 20, and the other shrink sleeve 21 is used for connection of the flexible tube 20 to the tubular attachment 8 of the element 5.

In the next step, the small tubes 11, 12 are passed through the tubular attachment 8 of the element 5.

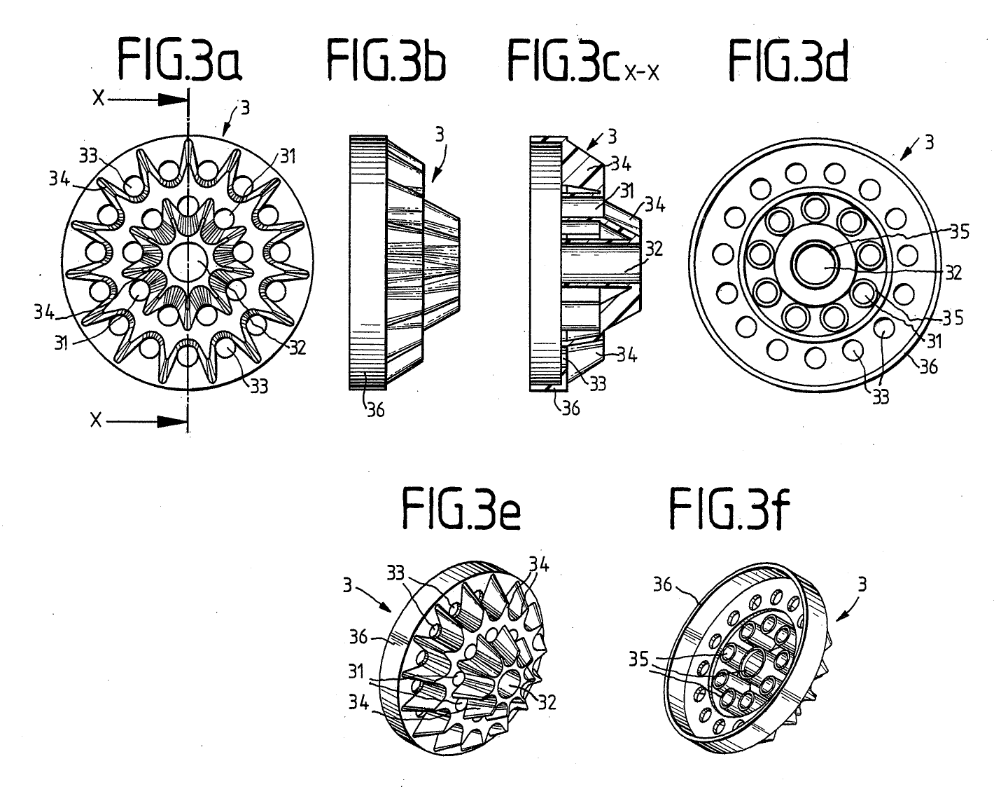

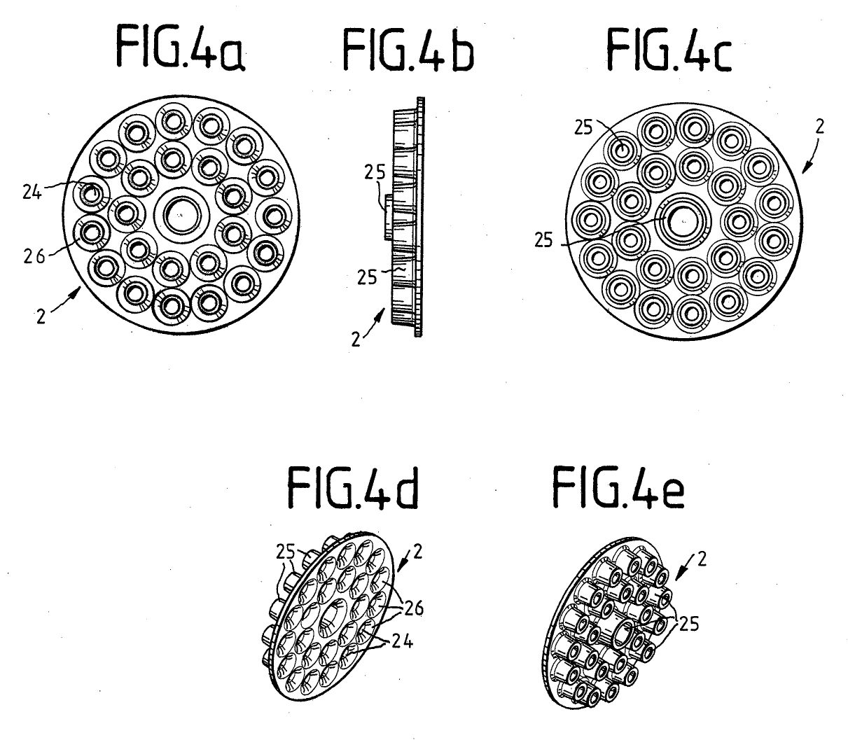

The inner small tubes 12 are then first of all passed into openings 31 in the splitting element 3. The concealed, centrally located core of the blown-fiber cable 10 is passed through a central opening 32. The openings 31 are in this case arranged concentrically around the opening 32. Once the inner small tubes 12 have been passed through, the outer small tubes 11 are then passed through openings 33. The openings 33 are likewise arranged concentrically around the opening 32. Rounded half-open guide elements 34 are arranged before each of the openings 31, 33 and make it easier to insert the small tubes 11, 12 (see FIGS. 3a, 3f). As can be seen in particular from FIG. 3e, the openings 31, 32 and 33 lie on three different planes. Cylindrical guides 35 are located behind the openings 32 and 31 and guide the core and the inner small tubes 12 to the plane of the openings 33, as can be seen particularly well in FIG. 3f. Furthermore, the splitting element 3 has a circumferential edge 36, which clasps the sealing element 2.

In the next step, the inner small tubes 12 including the core, and then the outer small tubes 11, are passed through seals 24. The seal 24 for the core is in this case arranged centrally, with the seals 24 for the inner small tubes 12 being arranged concentrically around the seal 24 for the core. The seals 24 for the outer small tubes 11 are likewise arranged concentrically. For this purpose, the seals 24 have openings on the cable side, which openings are aligned with the openings 31-33 in the splitting element 3. On the collar side, the seals 24 have outward bulges 25 in the form of truncated cones, which then surround the small tubes 11, 12 in a moisture-tight manner. The outward bulge 25, which is in the form of a truncated cone, for the core is in this case somewhat longer than the outward bulges for the small tubes 11, 12. In order to make it easier to insert the small tubes 11, 12 and the core, depressions 26 in the form of funnels are arranged before the openings on the cable side. The sealing element 2 is in this case preferably formed from an elastomer material.

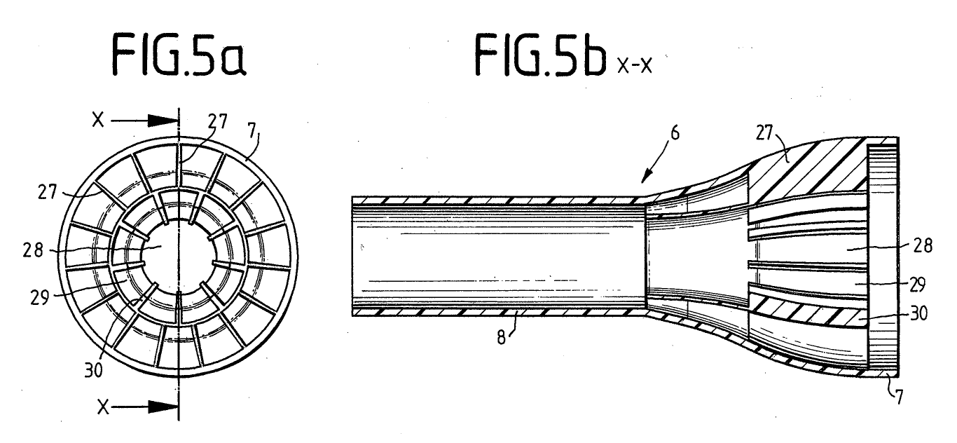

The small tubes 11, 12 including the core are then passed through the bundling element 4. The bundling element 4 can in this case be in the form of a separate component, which is pressed into the element 6 (see FIG. 1) or else may be in the form of an integral component of the element 6. The bundling element 6 has webs 27 which support the bundling element 4 (see FIG. 5a) on the cap 7 of the element 6. Furthermore, the bundling element 4 has a central aperture opening 28, into which the inner small tubes 12 are inserted. Furthermore, the bundling element 4 has annular segments 29 which are separated from one another by webs 30, with the annular segments 29 tapering in the direction of the tubular attachment 8, such that the outer small tubes 11 are guided more densely to the inner small tubes 12 in order then to continue as a compact bundle in the tubular attachment 8 (see FIG. 5b).

Finally, the two caps 7 are joined together and are connected to one another in a sealed form, and the tubular attachment 8 of the element 6 is inserted through an elastomer seal 40 of a collar 50, a part of which is illustrated in FIG. 6. The collar 50 has a housing lower part 51 which has detachable attached annular segments 52. A holding element 53 is screwed to the housing lower part 51 and comprises an annular section 54 through which the tubular attachment 8 is passed. The function of the holding element 53 is in this case, in particular, to mechanically hold the tubular attachment 8.

If moisture enters the flexible tube through one of the shrink connections or as a result of damage to the flexible tube, then the sealing element 2 prevents this moisture from entering the collar 50.

### LIST OF REFERENCE SYMBOLS

1 Apparatus

2 Sealing element

3 Splitting element

4 Bundling element

5, 6 Elements

7 Cap

8 Tubular attachment

10 Blown-fiber cable

11 Outer small tube

12 Inner small tube

13 Sheath

20 Flexible tube

21 Shrink sleeve

24 Seals

25 Outward bulges

26 Funnel-shaped depressions

27 Webs

28 Central aperture opening

29 Annular segments

30 Webs

31-33 Openings

34 Guide elements

35 Cylindrical guide

36 Circumferential edge

40 Elastomer seal

50 Collar

51 Housing lower part

52 Annular segments

53 Holding element

54 Annular section

1. An apparatus for sealing small tubes of a blown-fiber cable on insertion into a collar, comprising a sealing element, a splitting element, a bundling element and at least one covering element, with the sealing element having a number of seals corresponding to the number of small tubes, with the splitting element being arranged on the cable side before the sealing element, and with the bundling element being arranged on the collar side behind the sealing element.

2. The apparatus as claimed in claim 1, wherein the seals are arranged concentrically on the sealing element.

3. The apparatus as claimed in claim 1, wherein the seals have outward bulges in the form of truncated cones on the collar side.

4. The apparatus as claimed in claim 1, wherein the covering elements are in the form of two elements with a cap and a tubular attachment, with the caps surrounding the sealing element.

5. A method for sealing small tubes of a blown-fiber cable on insertion into a collar, comprising the following method steps:
a) stripping of the blown-fiber cable,
b) spreading out the small tubes by passing the small tubes through openings in a splitting element,
c) passing the spread-out small tubes through respective seals of a sealing element, and
d) passing the small tubes through an opening in a bundling element.

6. The method as claimed in claim 5, wherein the outer small tubes are shorter than the inner small tubes, such that the inner small tubes are passed through the sealing element first of all, followed by the outer small tubes.

7. The method as claimed in claim 5, wherein, after the stripping of the blown-fiber cable, the small tubes are first of all passed through a flexible tube and at least one shrink sleeve and are then passed through an element with a tubular attachment and a cap before they are spread out by the splitting element.

8. The method as claimed in claim 7, wherein, after being passed through the bundling element, the small tubes are passed through a further element with a cap and a tubular attachment.

9. The method as claimed in claim 7, wherein a shrink connection is produced by means of the at least one shrink sleeve between the tubular attachment of the first element and the flexible tube.

10. The method as claimed in claim 8, wherein the tubular attachment of the further element is inserted into the collar, and is sealed in an elastomer seal in the collar.
